(19) United States
(12) Patent Application Publication
(10) Pub. No.: US 2008/0170765 A1
(43) Pub. Date: Jul. 17, 2008

(54) Targeted Additive Gain Tool For Processing Ultrasound Images

(75) Inventors: Alwyn P. D'sa, Cambridge, MA (US); Ivan S. Salgo, Pelham, NH (US); William H. Kelton, Manchester, NH (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/912,509

(22) PCT Filed: Apr. 20, 2006
(86) PCT No.: PCT/IB2006/051225

§ 371 Date: Oct. 25, 2007

Related U.S. Application Data
(60) Provisional application No. 60/674,492, filed on Apr. 25, 2005.

(51) Int. Cl. G06K 9/00

(52) U.S. Cl. 382/128

(57) ABSTRACT

Ultrasound image processing system including a processor (16) for receiving a sequence of ultrasound image frames each including an object with a border and causing the ultrasound image frames to be displayed, and a user input device (20) for designating variable local regions of the displayed ultrasound image frames. A border detection algorithm (22) detects the border of the object in the ultrasound image frames and a target additive gain (TAG) tool (24) selectively adjusts pixel intensity in at least one local region of the ultrasound image frames with an unclear or non-existent border segment in order to make the pixel intensity more uniform. A more uniform pixel intensity improves the discerning of the border of the object via the border detection algorithm (22). Once the border of the object is sufficiently discernible, the object can be reviewed or quantified. If the object is the heart, the LV volume can be determined.

### FIELD OF THE INVENTION

The present invention relates generally to techniques for processing ultrasound images and more particularly to methods and systems for improving the visualization of borders of objects in ultrasound images for review and/or quantification. In particular, the present invention relates to an ultrasound image processing system and method in which ultrasound images of a human heart are processed for the purpose of analyzing borders of the heart to derive medical information about the patient's heart.

### BACKGROUND OF THE INVENTION

Accurate quantification of left ventricular (LV) volumes and the Ejection Fraction (EF) is important for clinical management and prognosis of cardiac disease as well as for serial study follow-up in therapy. Such quantification relies on accurate delineation of LV borders in cardiac ultrasound images which are typically obtained by semi-automatic border detection tools or algorithms used in the quantification process.

However, cardiac ultrasound images have several inherent technical limitations such as inadequate spatial resolution of the LV myocardial walls, clutter in the LV cavity, echo dropouts resulting from rib shadowing and attenuation from passage of the ultrasound waves through tissue, and sub-optimal angles of transmission of the ultrasound beam with respect to the tissue target, all of which result in a reduced received signal at the transducer. The net effect of these limitations are ultrasound images that are not uniformly illuminated over the entire field of view. The absence of uniform illumination causes difficulties when delineating the LV borders upon application of border detection algorithms.

To compensate for the non-uniform illumination in ultrasound images, ultrasound image processing systems usually include Time-Gain Compensation (TGC) and Lateral-Gain Compensation (LGC) controls to allow a user to adjust the illumination in an attempt to improve the resolution of the images prior to application of the border detection algorithm. However, use of these controls entails a constant static setting of the ultrasound receiver gains which is applied to all frames of the acquired ultrasound image sequence of the moving heart, even though not all frames require gain compensation. Gain applied to frames which do not require it adversely affects the image quality thereof.

Furthermore, the intensity in each particular region of the ultrasound image cannot be precisely controlled using TGC-LGC combination controls without affecting the intensity (hence the tracked border) in adjoining, neighborhood regions of the image. Ideally, what is required is an adaptive gain compensation scheme that can be selectively applied by the user in localized regions of diminished intensity in one specific frame of an imaging sequence to allow the border detection algorithm to detect and display the border therein, and then adaptively track the border in all consecutive frames of the acquired image sequence based on the gain compensation.

### OBJECTS AND SUMMARY OF THE INVENTION

It is an object of the present invention to provide a new and improved method and system for processing ultrasound images and ultrasound imaging systems including or applying the same.

It is another object of the present invention to provide an ultrasound image processing tool which enables compensation for non-uniform illumination in ultrasound images to form ultrasound images with a more uniform intensity or brightness.

It is another object of the present invention to provide a method and system for adaptive gain compensation in ultrasound images that can be applied to localized regions of the images to allow better detection and display of the border of an object in the images.

It is yet another object of the present invention to provide a method and system for adaptive gain compensation applicable to ultrasound image processing which can be selectively applied by the user in localized regions of diminished pixel intensity.

It is still another object of the present invention to provide an ultrasound image processing system and method that can be used either on-line in conjunction with an ultrasonic imaging system which contemporaneously obtains ultrasound images or off-line based on stored image data.

In order to achieve these objects and others, an ultrasound image processing system in accordance with the invention includes a processor for receiving a sequence of ultrasound image frames each including an object with a border and causing the ultrasound image frames to be displayed, and a user input device coupled to the processor for designating variable local regions of the ultrasound image frames shown on the display. The processor includes a border detection algorithm for detecting the border of the object in the ultrasound image frames and a target additive gain (TAG) tool for selectively adjusting intensity of pixels in at least one local region of the ultrasound image frames with an unclear or non-existent border segment. Use of the TAG tool enables the pixel intensity in the local region(s) of the image frames to be adjusted, either increased or decreased depending on the application, in order to make the pixel intensity of the image frames more uniform. A more uniform pixel intensity improves the display of the border of the object obtained upon application of the border detection algorithm. Once the border of the object is sufficiently discernible, the object can be reviewed or quantified as desired. If the object is the heart, the LV volume can be quantified.

In one embodiment, the TAG tool is applied to only one ultrasound image frame in a sequence, after which the border detection algorithm is applied until the entire border is sufficiently clear, and the processor then modifies the remaining ultrasound image frames in the sequence based on the pixel intensity adjustments made to the first ultrasound image frame. The processor can also track the border of the object when modifying the remaining ultrasound image frames in the sequence to ensure intensity adjustments in the remaining ultrasound image frames encompass the border of the object. This is particularly important for dynamic objects.

The user input device may be a mouse arranged to enable designation of each local region with an unclear or non-existent border segment, e.g., by positioning a cursor in the region, whereby the TAG tool effects an adjustment in pixel intensity in each designated local region upon pressing a button on the mouse. Other user input devices can also be used.

Using the image processing system described above, various image processing methods can be performed. One exemplifying method includes designating at least one local region with an unclear or non-existent border segment on a first ultrasound image frame in the sequence of ultrasound images, incrementally adjusting pixel intensity in each designated local region and then applying a border detection algorithm until all border segments in the first ultrasound image frame are discernible, and modifying remaining ultrasound image frames in the sequence based on the intensity adjustments made to the first ultrasound image frame. The border of the object may be tracked when modifying the remaining ultrasound image frames in the sequence to ensure intensity adjustments in the remaining ultrasound image frames encompass the border of the object.

Designation of each local region may entail positioning a cursor over a point on the frame ultrasound image frame where the border segment is unclear and a user input device may then be actuated to cause the incremental adjustment in pixel intensity in an area surrounding the cursor. Each actuation of the user input device causes an incremental adjustment in pixel intensity, e.g., either an increase or decrease in pixel intensity. The incremental adjustment in pixel intensity may be determined from a comparison of attributes of one or more regions of the first ultrasound image frame having a clear border and attributes of one or more regions having an unclear or non-existent border. The user can determine the parameters of the area surrounding the cursor to which an adjustment in pixel intensity is to be applied, e.g., the size and shape thereof.

### BRIEF DESCRIPTION OF THE DRAWINGS

The invention, together with further objects and advantages thereof, may best be understood by reference to the following description taken in conjunction with the accompanying drawings wherein like reference numerals identify like elements.

FIG. 1 shows a schematic of a system for ultrasound image generation and processing in accordance with the invention.

FIG. 2 shows an approximation of an ultrasound image of the left-ventricular short-axis view of a human heart before application of the method in accordance with the invention.

FIG. 3 shows an approximation of an ultrasound image of the left-ventricular short-axis view of a human heart after application of the method in accordance with the invention.

### DETAILED DESCRIPTION OF THE INVENTION

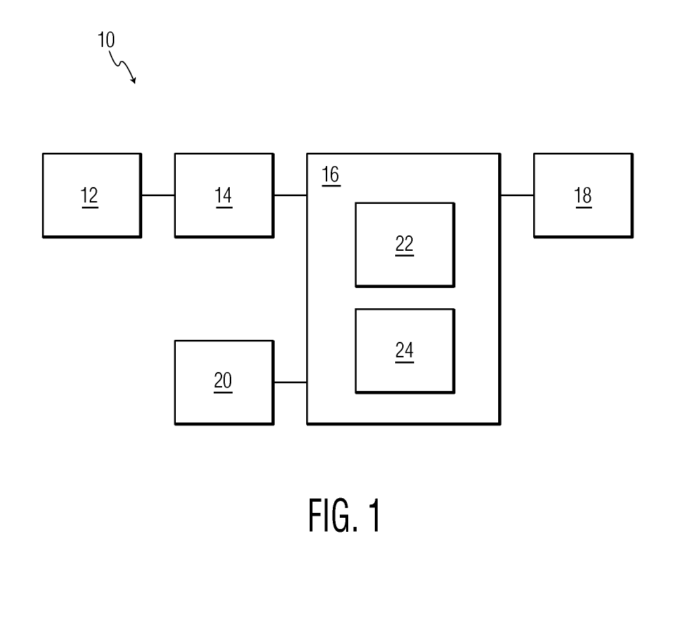

Referring to FIG. 1, an ultrasound imaging system in accordance with the invention is designated generally as 10 and includes an ultrasound transducer 12 which receives ultrasound waves from an object whose border provides information and/or which is sought for review, an image former 14 which forms images from the received ultrasound waves, and a processor 16 capable of adjusting the images and causing the display of the adjusted images on a display device 18. One or more user input devices 20, such as a keyboard and mouse, are connected to the processor 16 to control the adjustment and display of the images on the display device 18, as well as operating parameters of the ultrasound transducer 12. Ultrasound imaging system 10 also includes other components known to those skilled in the art which are necessary for the reception of ultrasound waves by the ultrasound transducer 12. The manner in which ultrasound waves are acquired and images formed therefrom is not critical to the invention and any type of ultrasound imaging system can be used to acquire ultrasound waves and form ultrasound images.

Processor 16 includes software to implement the invention, specifically, a border detection algorithm 22 to perform border detection, and a target additive gain (TAG) tool 24 to enable a user to selectively adjust the intensity of pixels in localized regions of frames of ultrasound images formed by the image former 14. Use of the TAG tool 24 is preferably enabled by the user input device 20.

An exemplifying method for processing ultrasound images in accordance with the invention will now be described.

Initially, a sequence or series of ultrasound image frames including an object having borders about which information is sought or which is sought for review, e.g., the human heart including the LV volume, is formed. The image frames are formed by the image former 14 from ultrasound waves acquired by the ultrasound transducer 12. In some implementations of the invention, the image former 14 is situated proximate the processor 16 or housing thereof, e.g., microcomputer, and the processor 16 can process images formed immediately before by the image former 14. For example, the image former 14 might be situated in the same room as the microcomputer housing the processor 16 and be connected thereto via a cable and the image former 14 and processor 16 might even be situated in a common housing, i.e., an on-line arrangement. Alternatively, in an off-line arrangement, the image former 14 and microcomputer housing the processor 16 are situated apart from one another, e.g., in separate rooms, and connected together via a network with image data from the image former 14 being transmitted over the network to the processor 16. The image data can be stored on the network, e.g., in a memory device, so that when it is desired to begin processing the images at a later time, image frames formed during the examination are retrieved from the memory device to start the image processing thereof by the processor 16. Instead of a network having a memory device for storing image data, any memory device for storing image data to enable image data obtained during an examination to be processed at a later time can be used, e.g., a removable memory device which can engage with both the image former 14 and the processor 16 can be provided. In an off-line arrangement, an image processing system in accordance with the invention would include the processor 16, display 18 and user input device 20 but would not include the ultrasound transducer 12 and image former 14 and would function upon input of any stored image data.

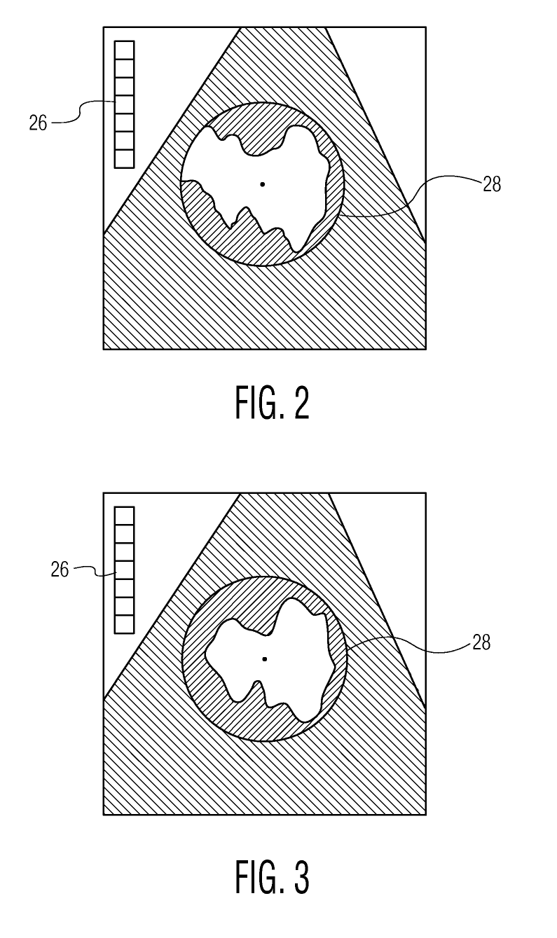

The border detection algorithm 22 is then applied to the ultrasound image frames to detect the borders of the object with the resultant processed images being displayed on the display device 18. The border detection algorithm 22 may be applied to all parts of the image frames, or alternatively, a region-of-interest (ROI) 28 including the object may be demarcated on an initial image frame via the user input device 20 and the border detection algorithm 22 applied only to the ROI 28. This can be seen in FIG. 2 wherein the ROI 28 is a demarcated circle in which the LV volume of the human heart is shown after application of the border detection algorithm 22 (and before application of the TAG tool 24).

After application of the border detection algorithm 22, the displayed images on the display 18 are reviewed to ascertain whether all segments of the border of the object are clearly displayed. If so, the border of the object can be reviewed or quantified to obtain information therefrom and another sequence of image frames obtained for additional processing. Various controls to effect image processing are shown as control areas 26 in FIG. 2.

When one or more border segments are not displayed or not sufficiently clear, e.g., because of impaired image quality, the TAG tool 24 is applied. Application of the TAG tool 24 allows a user to selectively apply adaptive gain compensation in localized regions of diminished intensity in one specific image frame of the sequence, typically the initial image frame of the sequence, to allow the border detection algorithm 22 to detect and display the border therein. Thereafter, the intensity of the remaining image frames in the sequence is modified and the border of the object is tracked in the remaining image frames based on the gain compensation (pixel intensity adjustment) applied by the user to the first image frame. Such tracking is necessary when the object is dynamic, which is the case when performing an ultrasound examination of the heart. Analysis of the sequence of ultrasound image frames is then performed after the intensity of the image frames is modified in conjunction with the tracking of the border of the object.

For example, when a sequence of image frames of a human heart is obtained for the purpose of determining the LV border in order to quantify the LV volume, the modified intensity changes provided by the user in the initial image frame act as a seed for tracking the tissue borders in the respective localized regions of the LV myocardium in all subsequent frames of the sequence by using, e.g., a cross-correlation technique with a pre-selected optimal search region. Other techniques for tracking borders can also be applied in the invention.

The first step in the application of the TAG tool 24 is to display one image frame of the sequence, usually the initial image frame. If the object being imaged is the heart, the initial image frame to be modified by the user is preferably the first end-diastolic (ED) frame. A region on the initial image frame where the border segment is not displayed or is not sufficiently clear is designated (see the area in the upper left quadrant in the ROI 28 designated in FIG. 2 which does not contain a border segment) and an incremental adjustment in the intensity of the pixels in the image at the designated region on the image is effected, i.e., an increase in pixel intensity in this case. Designation of the region in which to increase the pixel intensity may be achieved by manipulating the user input device 20 to position a cursor in the region. For purposes of actuating the TAG tool 24, the user input device 20 is preferably a mouse. As the mouse is moved, a cross-hair cursor on the display is moved and may be positioned in the center of the region or over the expected position of the border segment. The pixel intensity increase is then effected by actuating a button on the mouse, i.e., right-clicking the mouse, so that the intensity or brightness of the pixels in a small neighborhood around the cursor is increased. The size and/or shape of the region affected by this localized gain increase are user-configurable.

After each incremental increase in the intensity of the pixels in the designated region, the border detection algorithm 22 is applied and a determination is made by the user whether the border segment in that region is adequately displayed. This typically occurs when the increased intensity of the pixels exceeds an intensity threshold of the border detection algorithm 22 thereby causing the display of a border segment in that region. If the border remains unclear, the intensity is again incrementally increased (by actuating the user input device) until the increased intensity exceeds the intensity threshold of the border detection algorithm 22 thereby resulting in an adequately displayed border segment in that region.

The amount of intensity change provided by each actuation of the user input device 20 may be determined from a comparison of image statistics or attributes (such as histograms) of regions that display border segments and those that showed dropouts, and an appropriate scaling factor for the required image increase is determined. Alternatively, the incremental pixel intensity increase can be determined from texture analysis or other known techniques used in fundamental image analysis.

Once the border segment in the designated region is discernible to the satisfaction of the user, a determination is made whether there are any additional regions with unclear border segments. If so, one of these additional regions is designated and the intensity of the pixels in this designated region is incrementally increased until it exceeds the intensity threshold of the border detection algorithm 22 and the border segment is clearly displayed. When there are no more regions with unclear border segments, application of the TAG tool 24 ends and a continuous border defining the object would thus be displayed (see FIG. 3).

In the exemplifying method above, the border detection algorithm 22 is applied before application of the TAG tool 24. However, it is also possible to apply the TAG tool 24 before any application of a border detection algorithm 22. In this case, the TAG tool 24 is applied when it is evident that there are unclear segments of the border of an object in the ultrasound images.

The TAG tool 24 described above can be used instead of conventional TGC/LGC compensation controls. Alternatively, it can be used to aid the border detection process after attempts to change the image intensity with the TGC/LGC controls have failed. In this case, the processor 16 is capable of both applying the TAG tool 24 for selective gain compensation and allowing non-selective gain compensation which would be applied to all the pixels in an ultrasound image frame.

The method described above is particularly suitable for processing two-dimensional ultrasound images, although three-dimensional and four-dimensional images could also be processed using the same techniques, i.e., by the TAG tool 24 described above.

Additional uses of the TAG tool 24 include its application to both pre-scan and post-scan converted image data and for image review and/or image quantification. In addition, the TAG tool 24 can be applied manually as described above, wherein the user must designate a region with an unclear border segment to which the TAG tool 24 will be applied, or automatically, i.e., with computer assistance. In the latter case, the processor 16 might be designed to trace a border around an object and wherever the border is discontinuous, the processor 16 would automatically apply the TAG tool 24 until a continuous border appears.

Another variation in the method involves incrementally reducing the intensity of the pixels in a designated region, i.e., subtracting image intensity instead of increasing the intensity as described above. Various image processing kernels can be applied to achieve this effect. Also, the TAG tool 24 can be applied in a plurality of regions of the same image to track the border of an object in the image.

Although illustrative embodiments of the present invention have been described herein with reference to the accompanying drawings, it is to be understood that the invention is not limited to these precise embodiments, and that various other changes and modifications may be effected therein by one of ordinary skill in the art without departing from the scope or spirit of the invention.

1. An ultrasound image processing system, comprising:
a display (18) for displaying ultrasound images;
a processor (16) for receiving a sequence of ultrasound image frames each including an object with a border and causing the ultrasound image frames to be displayed on said display (18); and
a user input device (20) coupled to said processor (16) for designating variable regions of the ultrasound image frames shown on said display (18),
said processor (16) including a border detection algorithm (22) for detecting the border of the object in the ultrasound image frames and a target additive gain (TAG) tool (24) for selectively adjusting intensity of pixels in at least one local region of the ultrasound image frames with an unclear border segment.

2. The processing system of claim 1, wherein said user input device (20) is arranged to enable designation of the at least one local region with an unclear or non-existent border segment on a first ultrasound image frame in the sequence of ultrasound image frames when the first ultrasound image frame is shown on said display (18) and said TAG tool (24) is arranged to effect an adjustment in pixel intensity in each designated local region upon actuation of said user input device (20).

3. The processing system of claim 2, wherein said user input device (20) is a mouse having at least one actuatable button, said processor (16) being arranged to position a cursor on the first ultrasound image frame based on the position of said mouse (20) and said TAG tool (24) is arranged to cause the adjustment in pixel intensity in an area around the cursor upon actuation of said at least one button.

4. The processing system of claim 2, wherein said processor (16) is arranged to apply said border detection algorithm (22) upon the adjustment in pixel intensity caused by said TAG tool (24) and modify remaining ultrasound image frames in the sequence based on the pixel intensity adjustments made to the first ultrasound image frame.

5. The processing system of claim 4, wherein said processor (16) is arranged to track the border of the object when modifying the remaining ultrasound image frames in the sequence to ensure intensity adjustments in the remaining ultrasound image frames encompass the border of the object.

6. The processing system of claim 1, wherein said TAG tool (24) is arranged to increase the intensity of the pixels in the at least one local region.

7. The processing system of claim 1, wherein said TAG tool (24) is arranged to decrease the intensity of the pixels in the at least one local region.

8. An ultrasound imaging system (10), comprising:
an ultrasound transducer (12) for receiving ultrasound waves from an object with a border;
an image former (14) coupled to said transducer (12) for forming images from the received ultrasound waves; and
the ultrasound image processing system of claim 1, said processor (16) receiving the ultrasound image frames from said image former (14).

9. A method for processing a sequence of ultrasound image frames having an object with at least one unclear or non-existent border segment, comprising:
designating at least one local region with an unclear or non-existent border segment on a first ultrasound image frame in the sequence of ultrasound images;
incrementally adjusting pixel intensity in each designated local region and then applying a border detection algorithm (22) until all border segments in the first ultrasound image frame are discernible; and
modifying remaining ultrasound image frames in the sequence based on intensity adjustments made to the first ultrasound image frame.

10. The method of claim 9, wherein the object is an organ of the human body whose border is being analyzed.

11. The method of claim 9, further comprising tracking the border of the object when modifying the remaining ultrasound image frames in the sequence to ensure intensity adjustments in the remaining ultrasound image frames encompass the border of the object.

12. The method of claim 9, further comprising applying the border detection algorithm (22) prior to the designation of any local regions on the first ultrasound image frame.

13. The method of claim 9, wherein the step of designating each local region comprises positioning a cursor over a point on the ultrasound image frame where the border segment is unclear or non-existent and the step of incrementally adjusting the pixel intensity comprises actuating a user input device (20) to cause an incremental adjustment in pixel intensity in an area surrounding the cursor, each actuation of the user input device (20) causing an incremental adjustment in pixel intensity.

14. The method of claim 13, further comprising enabling the user to determine the parameters of the area surrounding the cursor to which an adjustment in pixel intensity is to be applied.

15. The method of claim 9, further comprising determining the incremental adjustment in pixel intensity from a comparison of attributes of regions of the first ultrasound image frame having a clear border and attributes of regions having an unclear or non-existent border.

16. The method of claim 9, wherein the sequence of ultrasound image frames is pre-scan converted image data.

17. The method of claim 9, wherein the object is a human heart whose left ventricular border is being analyzed.

18. The method of claim 17, further comprising selecting the first ultrasound image frame as the first end diastolic frame of a heart cycle.

19. The method of claim 9, wherein the adjustment of pixel intensity is an increase in pixel intensity.

20. The method of claim 9, wherein the adjustment of pixel intensity is a decrease in pixel intensity.
